(19) United States
(12) Patent Application Publication
(10) Pub. No.: US 2017/0022317 A1
(43) Pub. Date: Jan. 26, 2017

(54) NATURAL OIL DERIVED BLOCKED PREPOLYMERS AND ACRYLIC PLASTISOL COMPOSITIONS HAVING THE BLOCKED PREPOLYMERS

(71) Applicant: Dow Global Technologies LLC, Midland, MI (US)

(72) Inventor: Masayuki SUZUKI, Chuo-ku (JP)

(21) Appl. No.: 15/104,363

(22) PCT Filed: Mar. 30, 2015
(86) PCT No.: PCT/US2015/023244

§ 371 Date: Jun. 14, 2016

Related U.S. Application Data
(60) Provisional application No. 61/972,565, filed on Mar. 31, 2014.

(51) Int. Cl. C08G 18/80; C08L 33/00; C08G 18/76; C08G 18/12; C08G 18/48

(52) U.S. Cl. CPC C08G 18/8067; C08G 18/12; C08G 18/4816; C08G 18/7621; C08L 33/00

(57) ABSTRACT

A natural oil derived blocked prepolymer is a reaction product of a composition including an isocyanate terminated prepolymer that is the reaction product of a mixture that has at least one or more polyols including at least one polyol having a secondary amine initiator or a tertiary amine initiator and a stoichiometric excess of one or more organic polyisocyanate components of which the stoichiometric excess of isocyanate to alcohol moieties (NCO:OH) is from 1.1:1 to 4:1, and a natural oil derived blocking agent. The viscosity of the natural oil derived blocked prepolymer is from 50,000 Pa*s to 300,000 Pa*s. An acrylic plastisol composition comprises the natural oil blocked prepolymer, one or more acrylic powders, one or more plasticizers, one or more amine crosslinkers, and optionally, one or more fillers.

### FIELD

Embodiments relate to natural oil derived blocked prepolymers and to plastisol compositions that include the natural oil derived blocked prepolymers.

### INTRODUCTION

Polyvinyl chloride (PVC) resins, suspensions, dispersions, or emulsions are commonly dispersed in liquid plasticizers (with other additives) to form a plastisol. PVC-based plastisols have been used, e.g., as an automotive and heavy machine chip-resistant undercoat, a body sealer, and an electrodeposition coating for wire-coating applications. However, PVC-based plastisols are alleged to present challenges to the environment and health. Recently, environmentally friendly plastisol formulations such as acrylic-based plastisol compositions have been accepted as substitutes for PVC-based plastisols by some automotive and heavy machinery manufacturers.

Acrylic-based plastisol compositions are thermoplastic and use heat and time for fusion. Exemplary, acrylic-based plastisol compositions that use blocked prepolymers are discussed in International Publication No. WO 2013/016265. It is desirable to identify blocked prepolymers that provide both the desired characteristics of acrylic-based plastisol compositions and additional environmental and viscosity based benefits.

### SUMMARY

Embodiments relate to a natural oil derived blocked prepolymer that is a reaction product of a composition including an isocyanate terminated prepolymer that is the reaction product of a mixture that has at least one or more polyols including at least one polyol having a secondary amine initiator or a tertiary amine initiator and a stoichiometric excess of one or more organic polyisocyanate components of which the stoichiometric excess of isocyanate to alcohol moieties (NCO:OH) is from 1.1:1 to 4:1, and a natural oil derived blocking agent. The viscosity of the natural oil derived blocked prepolymer is from 50,000 Pa*s to 300,000 Pa*s.

An acrylic plastisol composition comprises the natural oil blocked prepolymer, one or more acrylic powders, one or more plasticizers, one or more amine cross-linkers, and optionally, one or more fillers.

### DETAILED DESCRIPTION

Embodiments relate to natural oil derived blocked prepolymers and to acrylic-based plastisol compositions that are formed using natural oil derived components such as a natural oil derived polyol and/or a natural oil derived blocking agent. The natural oil derived blocking agent is derived from plants, e.g., may be cashew nutshell liquid that is derived from cashew nut processing and includes an alkylphenolic lipid such as cardanol. The natural oil derived blocked prepolymers are formed by reacting the blocking agent (such as the natural derived blocking agent and an isocyanate terminated prepolymer that is the reaction product of a mixture that includes at least one or more polyols including at least one polyol having a secondary amine initiator (e.g., upon alkoxylation of the initiator the secondary amine may be converted to a tertiary amine) or a tertiary amine initiator and a stoichiometric excess of one or more organic polyisocyanate components. The stoichiometric excess of isocyanate to alcohol moieties (NCO:OH) is from 1.1:1 to 4:1. The viscosity of the natural oil derived blocked prepolymer is from 50,000 Pa*s to 300,000 Pa*s (e.g., may be from 75,000 Pa*s to 300,000 Pa*s, 85,000 Pa*s to 150,000 Pa*s, 90,000 Pa*s to 125,000 Pa*s, 95,000 Pa*s to 115,000 Pa*s, etc.).

The presence of the tertiary amine in the polyol is believed to help catalyze reactions involving the isocyanate, such as reaction with hydroxyl, carboxylic acid and/or amine groups. Thus such prepolymers contain some self-catalytic activity. It has been found that plastisols comprising the self-catalytically active blocked prepolymers and a natural oil derived blocking agent described herein may cure at temperatures around 120° C. and posses superior elongation and tensile strength while maintaining comparable hardness relative to plastisols formed without the blocked prepolymers described herein. The blocked prepolymers according to embodiments, which are incorporated with an amine initiated polyol, may provide improved physical properties in comparison with currently available blocked prepolymers and/or comparatively improved adhesion properties.

The presence of the natural oil derived blocking agent may enable the use of a phenol blocking agent without having to use nonylphenol. In this regard, the use of nonylphenol raises concerns about toxicity such as carcinogenic toxicity. Further, the use of some other phenols (e.g., some phenols with reduced toxicity concerns as compared to nonylphenol) may not be feasible based on relatively high melting points. For example, some phenols are believed to be solids at room temperature, which could make their use for blocked prepolymers and/or acrylic-based plastisol compositions relatively more difficult as compared to the use of a natural oil derived phenol based blocking agent such as cardanol.

According to an exemplary embodiment, a blocked prepolymer is provided. The blocked prepolymer includes (a) an isocyanate terminated prepolymer and (b) a blocking agent. The isocyanate terminated prepolymer (a) is the reaction product of a mixture that includes at least (1) one or more polyols comprising at least one polyol having a secondary amine initiator or tertiary amine initiator and (2) a stoichiometric excess of one or more organic polyisocyanate components, of which the stoichiometric excess of isocyanate to alcohol moieties (NCO:OH) is from 1.1:1 to 4:1.

### Component (a) of Prepolymer Formulation

Component (a) used to prepare the blocked prepolymer includes (1) one or more polyols comprising at least one polyol having an amine based initiator. The at least one polyol having an amine based initiator may have an average molecular weight of from 1,000 to 12,000 g/mol (e.g., 1,500 to 8,000, 2,000 to 6,000, 3,000 to 5,000, 3,500 to 4,500, etc.). The polyol having an amine based initiator may be obtained by alkoxylation of an initiator comprising at least one molecule of the formula:

HₘA-(CH₂)ₙ—N(R)—(CH₂)ₚ-AHₘ (I)

where n and p are independently integers from 2 to 6; A at each occurrence is independently oxygen or nitrogen; R is a C₁ to C₃ alkyl group; and m is 1 when A is oxygen and m is 2 when A is nitrogen; or of the formula

H₂N—(CH₂)ₜ—N(R)—H (II)

where t is an integer from 2 to 12 and R is a C₁ to C₃ alkyl group.

In an exemplary embodiment of Formula I, R is methyl. In another exemplary embodiment R is methyl and n and p are integers of the same value. In another exemplary embodiment n and p are an integer of 2 to 4. In one embodiment one A will be oxygen and the other A will be nitrogen, and the final polyol will be a triol. In yet another embodiment, A is nitrogen in all occurrences and the final polyol will be a tetrol.

The alkyl amines of Formula I are commercially available or can be made by techniques known in the art, e.g., as discussed in U.S. Pat. No. 4,605,772. For example, methylamine is reacted with the appropriate alkylene oxide or combination of alkylene oxides for producing compounds where A is oxygen. The alkylene oxide may be ethylene oxide (EO), propylene oxide (PO), and/or butylene oxides (BO). The alkylene oxide or combination of alkylene oxides may give a range of 2 to 4 for n when each A is oxygen. Examples of such initiator compounds include N-methyldiethanolamine, N-methyldipropanolamine, N-methyldibutanol-amine, and N-methylethanol-propanol-amine.

For producing compounds where each A is nitrogen, a methyl amine can be reacted with known reactive group that reacts with an amine and contains additional nitrogen. For example, 2 moles of X(CH₂)ₙNR′R″ can be reacted with one mole of methylamine, where X represents chlorine, bromine or iodine; R′ and R″ can be H or an alkyl group; and n is as defined above. Examples of such initiator compounds include 3,3′-diamino-N-methyldipropylamine, 2,2′-diamino-N-methyldiethylamine, and 2,3-diamino-N-methyl-ethyl-propylamine.

For producing compounds where one A is nitrogen and one A is oxygen, a process known process may be used, e.g., such as the one described in JP 09/012,516.

In one embodiment of Formula II, R is methyl. In Formula II, t is an integer of 2 to 10 (e.g., an integer of 2 to 6, an integer of 2 to 4, etc.). In an exemplary embodiment, R is methyl and m is an integer of 2 to 4. Compounds of Formula II can be made by standard procedures known in the art. Examples of commercially available compounds of Formula II include N-methyl-1,2-ethanediamine, and N-methyl-1,3-propanediamine.

The production of polyols by alkoxylation of an initiator may be done by procedures known in the art. For example, a polyol may be made by the addition of an alkylene oxide (EO, PO, or BO), or a combination of alkylene oxides to the initiator by anionic or cationic reaction or use of double metal cyanide (DMC) catalyst. For some applications only one alkylene oxide monomer may be used, for some other applications a blend of monomers may be used, and in some cases a sequential addition of monomers (such as PO followed by an EO feed or EO followed by PO) may be used.

The polyol having an amine initiator may be methylimino bis-propylamine initiated EO/PO polyoxyalkylene ether copolymer. The polyol having an amine initiator may have a hydroxyl number from 50 mg KOH/g to 60 mg KOH/g (e.g., 52 mg KOH/g to 58 mg KOH/g, 55 mg KOH/g to 58 mg KOH/g, approximately 57 mg KOH/g, etc.). The polyol having an amine initiator may have an equivalent weight from 250 to 3,000 g/mol equivalents (e.g., from 750 to 1,500, approximately 1,000, etc.). The polyol having an amine initiator may be a triol or a tetrol. The polyol having an amine initiator may be a self-catalytically active polyol.

Exemplary polyols having an amine initiator (and may optionally be self-catalytically active) are available from the Dow Chemical Company under the trade name VORANOL™VORACTIV™ polyols. VORANOL™VORACTIV™ polyols are amine initiated polyols that may be used for adhesives, sealants, flex, and molding foam applications. Exemplary commercially available products of that type include VORANOL™VORACTIV™ 7000 which is available from the Dow Chemical Company.

The polyol having an amine initiator may comprise at least 1 wt %, 3 wt %, 5 wt %, 7 wt %, 9 wt %, 10 wt %, or 13 wt % of the total weight of the composition for forming the natural oil derived blocked prepolymer. The polyol having an amine initiator may comprise up to 3 wt %, 5 wt %, 7 wt %, 9 wt %, 10 wt %, 13 wt %, or 15 wt % of the total weight of the composition for forming the blocked prepolymer. In exemplary embodiments, the polyol having an amine initiator may comprise from 1 wt % to 10 wt % (e.g., 1 wt % to 7 wt %, 2 wt % to 5 wt %, etc.) of the total weight of the composition for forming the blocked prepolymer.

The polyol having an amine initiator may be used alone or can be blended with at least one other polyols (with other polyols are different from the polyol having an amine initiator) to produce polyol blends. Exemplary other polyols for polyol blends include polyether polyols (e.g., non-amine initiated), polyester polyols, and polyalkylene carbonate-based polyols. The functionality of polyol(s) used in a formulation may depend on the end use application as known to those skilled in the art.

Polyether polyols may be prepared by adding an alkylene oxide, such as ethylene oxide, propylene oxide, butylene oxide, or a combination thereof, to an initiator having from 2 to 8 active hydrogen atoms (e.g., such that the initiator includes hydroxyl groups and excludes amines). For example, exemplary polyether polyols for polymer formulation include those having a number average molecular weight from 100 to 10,000 g/mol (e.g., 1,000 to 8,000, 2,000 to 6,000, 3,000 to 5,000, 3,500 to 4,500, etc.). According to an exemplary embodiment, the polyether polyol and the amine initiated polyol are different polyols that have approximately the same number average molecular weight (e.g., from 3,500 to 4,500 g/mol). The polyether polyols may have a functionality from 2 to 8, of at least 2, at least 3, up to 8, up to 6, active hydrogen atoms per molecule. The polyols used for prepolymer formation may have a hydroxyl number from 10 to 200 mg KOH/g (e.g., 30 to 60 mg KOH/g, etc.). The one or more polyether polyols may include a polyoxypropylene containing polyol such as an ethylene oxide capped polyoxypropylene diol or triol and/or polyoxypropylene diol or triol. Exemplary polyether polyols are available from the Dow Chemical Company under the trade name VORANOL™. Exemplary commercially available products of that type include VORANOL™ 4701 and VORANOL™ 230-042 both of which are available from the Dow Chemical Company.

The representative polyols for blends with the polyol having an amine initiator may comprise at least 40 wt %, 45 wt %, 50 wt %, 55 wt %, 60 wt %, 65 wt %, 70 wt %, 75 wt %, 80 wt %, 85 wt %, and/or 90 wt % of the total weight of the composition for forming the blocked prepolymer. The representative polyols for blends with the polyol having an amine initiator (a) may comprise up to 45 wt %, 50 wt %, 55 wt %, 60 wt %, 65 wt %, 70 wt %, 75 wt %, 80 wt %, 85 wt %, 90 wt %, and/or 95 wt % of the total weight of the composition for forming the blocked prepolymer. In exemplary embodiments, a polyol blended have the amine initiated polyol and at least one other polyol may comprise from 75 wt % to 95 wt %, 80 wt % to 93 wt %, and/or 85 wt % to 92 wt %, of the total weight of the composition for forming the blocked prepolymer.

Component (2) may include one or more organic polyisocyanate components. The one or more organic polyisocyanate components may have an average of 1.8 or more isocyanate groups per molecule. The isocyanate functionality may be from 1.9 to 4 (e.g., 1.9 to 3.5, 2.0 to 3.3, etc.). Exemplary polyisocyanates include, e.g., m-phenylene diisocyanate, 2,4- and/or 2,6-toluene diisocyanate (TDI), the various isomers of diphenylmethanediisocyanate (MDI), and polyisocyanates having more than 2 isocyanate groups, MDI and derivatives of MDI such as biuret-modified “liquid” MDI products and polymeric MDI (PMDI), 1,3 and 1,4-(bis isocyanatomethyl)cyclohexane, isophorone diisocyanate (IPDI), hexamethylene diisocyanate (HDI), bis(4-isocyanatocyclohexyl)methane or 4,4′ dimethylene dicyclohexyl diisocyanate (H12MDI), xylylene diisocyanate (XDI), and combinations thereof, as well as mixtures of the 2,4- and 2,6-isomers of TDI. A 65/35 weight percent mixture of the 2,4 isomer to the 2,6 TDI isomer is typically used, but the 80/20 weight percent mixture of the 2,4 isomer to the 2,6 TDI isomer may be used. Exemplary TDI products are available under the trade name VORANATE™ which is available from The Dow Chemical Company and CORONATE T100 manufactured by Nippon Polyurethane Industry Co., Ltd. Other isocyanates include methylene diphenyl diisocyanate (MDI) and or its polymeric form (PMDI) for producing the prepolymers described herein. Such polymeric MDI products are available from The Dow Chemical Company under the trade names PAH® and VORANATE®. Exemplary commercially available products of that type include PAPI™ 2940 which is available from The Dow Chemical Company.

The organic polyisocyanate may be used in a stoichiometric excess (NCO:OH) of at least 1.05:1 (e.g., at least 1.10:1, at least 1.20:1, and at most 4:1, etc.) leaving a prepolymer having an isocyanate functionality.

The organic polyisocyanate component may comprise at least 1 wt %, 5 wt %, 10 wt %, 15 wt %, 20 wt %, and/or 25 wt.% of the total weight of the composition for forming the blocked prepolymer. The organic polyisocyanate component may comprise up to 5 wt %, 10 wt %, 15 wt %, 20 wt %, 25 wt %, or 30 wt % of the total weight of the composition for forming the blocked prepolymer. In exemplary embodiments, the organic polyisocyanate component may comprise from 5 wt % to 20 wt %, 6 wt % to 15 wt %, and/or 7 wt % to 10 wt % of the total weight of the composition for forming the blocked prepolymer.

The isocyanate-terminated prepolymer may be prepared by standard procedures known to a person skilled in the art, e.g., as disclosed in U.S. Pat. Nos. 4,294,951; 4,555,562; and 4,182,825; and International Publication No. WO 2004/074343. The components may be mixed together and heated to promote reaction of the polyols and the polyisocyanate. The reaction temperature will be within the range from 30° C. to 150° C. (e.g., from 60° C. to 100° C.). The reaction may be performed in a moisture-free atmosphere. An inert gas such as nitrogen and/or argon may be used to blanket the reaction mixture. If desired, an inert solvent can be used during preparation of the prepolymer, although the inert solvent may be excluded. A catalyst to promote the formation of urethane bonds may also be used. In one embodiment, a urethane bond promoting catalyst may be excluded. For producing the blocked prepolymers, the blocking agent may be added during the formation of the prepolymer.

Catalysts may be used in small amounts, e.g., each catalyst being employed from 0.0015 wt % to 5 wt % of the total weight of the composition for forming the blocked prepolymer. The amount depends on the catalyst or mixture of catalysts and the reactivity of the polyols and isocyanate as well as other factors familiar to those skilled in the art.

A known catalyst may be used. For example, catalyst that may catalyze prepolymer reactions include amine-based catalysts and tin-based catalysts. Exemplary catalysts include tertiary amine catalysts and organotin catalysts. Examples of commercially available include: trimethylamine, triethylamine, N-methylmorpholine, N-ethylmorpholine, N,N-dimethylbenzylamine, N,N-dimethylethanolamine, N,N-dimethylaminoethyl, N,N,N′,N′-tetramethyl-1,4-butanediamine, N,N-dimethylpiperazine, 1,4-diazobicyclo-2,2,2-octane, bis(dimethylaminoethyl)ether, triethylenediamine, and dimethylalkylamines where the alkyl group contains from 4 to 18 carbon atoms. Mixtures of tertiary amine catalysts may be used.

Examples of commercially available catalysts include NIAX™ A1 and NIAX™ A99 (bis(dimethylaminoethyl)ether in propylene glycol available from Momentive Performance Materials), NIAX™ B9 (N,N-dimethylpiperazine and N-N-dimethylhexadecylamine in a polyalkylene oxide polyol, available from Momentive Performance Materials), DAB CO® 8264 (a mixture of bis(dimethylaminoethyl)ether, triethylenediamine and dimethylhydroxyethyl amine in dipropylene glycol, available from Air Products and Chemicals), DABCO 33LV® (triethylene diamine in dipropylene glycol, available from Air Products and Chemicals), DABCO® BL-11 (a 70% bis-dimethylaminoethyl ether solution in dipropylene glycol, available from Air Products and Chemicals, Inc), NIAX™ A-400 (a proprietary tertiary amine/carboxylic salt and bis (2-dimethylaminoethyl)ether in water and a proprietary hydroxyl compound, available from Momentive Performance Materials); NIAX™ A-300 (a proprietary tertiary amine/carboxylic salt and triethylenediamine in water, available from Momentive Performance Materials); POLYCAT® 58 (a proprietary amine catalyst available from Air Products and Chemicals), POLYCAT® 5 (pentamethyl diethylene triamine, available from Air Products and Chemicals), and POLYCAT® 8 (N,N-dimethyl cyclohexylamine, available from Air Products and Chemicals).

Examples of tin catalysts include stannic chloride, stannous chloride, stannous octoate, stannous oleate, dimethyltin dilaurate, dibutyltin dilaurate, other organotin compounds of the formula SnRₙ(OR)₄₋ₙ, wherein R is alkyl or aryl and n is 0-2, and the like. Tin catalysts may be used in conjunction with one or more tertiary amine catalysts, if used at all. Commercially available catalysts include KOSMOS® 29 (stannous octoate from Evonik AG), DABCO® T-9 and T-95 catalysts (both stannous octoate compositions available from Air Products and Chemicals).

### Component (b) of Prepolymer Formulation

Component (b) used to prepare the blocked prepolymer includes a blocking agent component having at least one natural oil derived blocking agent and may optionally include other blocking agents. Of the at least one natural oil derived blocking agent, a cardanol based blocking agent may be used.

The cardanol based blocking agent may be a cashew nutshell liquid (CNSL) that is a by-product of cashew nut processing (e.g., may be extracted from a layer between a nut and a shell of a cashew nut). The CNSL may have a cardanol content of at least 85 wt %, based on a total weight of the CNSL, such that the CNSL includes cardanol as a primary component and may additionally include cardol, methylcardol, and/or anacardic acid as secondary components. The CNSL may be subjected to a heating process (e.g., at the time of extraction from the cashew nut), a decarboxylation process, and/or a distillation process. The CNSL includes at least 85 wt % (e.g., 85 wt % to 100 wt %, 90 wt % to 99 wt %, 91 wt % to 98 wt %, 92 wt % to 98 wt %, 93 wt % to 98 wt %, etc.) of cardanol, based on a total weight of the CNSL. The CNSL may include less than 8.5 wt % (e.g., from 0.5 wt % to 8 wt %, from 0.5 wt % to 5 wt %, 0.5 wt % to 3 wt %, etc.) of cardol, with a remainder based on a total of 100 wt % being methylcardol and/or anacardic acid. According to an exemplary embodiment, the cardanol component consists essentially of a decarboxylated CNSL that includes at least 92 wt % (e.g., 92 wt % to 100 wt %, 94 wt % to 100 wt %, etc.) of cardanol, based on a total weight of the decarboxylated CNSL. The decarboxylated CNSL may be exposed to at least one distillation process. Exemplary CNSL is available, e.g., from HDSG Beijing Technology under the tradename F-180 series.

In addition to the cardanol component, the one or more blocking agents may include another phenol containing blocking agent, a nitrogen containing blocking agents, and/or an amine containing blocking agent. Exemplary blocking agents include ketoximes of hydroxylamines, ketones, phenols, pyrazole, lactam, and amines. Ketones include, but are not limited to acetone, methyl ethyl ketone, diethyl ketone, cyclohexanone, acetophenone and benzophenone.

The blocking agent component may be used in an amount such that the equivalents of the groups of the blocking agent that are suitable for isocyanate blocking correspond to at least 60 mol % (e.g., at least 75 mol %, at least 85 mol %, at least 95 mol %, etc.) of the amount of isocyanate groups to be blocked. A small excess of blocking agent may assist in obtaining essentially complete reaction of all isocyanate groups. The excess may not be more than 20 mol % (not more than 15 mol %, not more than 10 mol %, etc.) based on the isocyanate groups to be blocked. For example, the amount of blocking agent groups used for NCO blocking may be from 95 mol % to 110 mol %, based on the amount of the isocyanate groups of the prepolymer that are to be blocked.

The blocking agent component may comprise at least 1 wt %, 3 wt %, 5 wt %, 7 wt %, 9 wt %, 10 wt %, 12 wt %, and/or 13 wt %, by weight of the blocked prepolymer. The blocking agent may comprise up to 14 wt %, 16 wt %, 18 wt %, 20 wt %, and/or 25 wt % of the blocked prepolymer. In certain embodiments, the blocking agent component may comprise from 1 wt % to 25 wt %, from 5 wt % to 20 wt %, 7 wt % to 15 wt %, and/or from 10 wt % to 14 wt % of the total weight of the composition for forming the blocked prepolymer. In the blocking agent component, the amount of the natural oil derived blocking agent may be greater than the amount of the other optional blocking agents (when included). For example, the blocking agent component may include a natural oil derived blocking agent that accounts for 5 wt % to 20 wt % and a blocking agent that is different from the natural oil derived blocking agent (e.g., that is not natural oil derived) that accounts for from 0 wt % to 5 wt % of the total weight of the composition for forming the blocked prepolymer. According to an exemplary embodiment, the blocking agent component includes CNSL, which accounts for 10 wt % to 14 wt % of the total weight of the composition for forming the blocked prepolymer.

The blocked prepolymer may be prepared by procedures known to a person skilled in the art. The components are typically mixed together and heated to promote reaction of the prepolymer and the blocking agent. The reaction temperature will commonly be within the range of 10° C. to 100° C. (e.g., from 30° C. to 60° C.). The reaction temperature may be less than 50° C. A catalyst to promote blocking may also be used.

### Plastisol Composition:

An acrylic plastisol composition that includes the natural oil derived blocked prepolymer may be formed. The acrylic plastisol composition may be the reaction product of the natural oil derived blocked prepolymer, one or more acrylic powders, one or more plasticizers, optionally one or more fillers, and one or more amine cross-linkers.

The natural oil derived blocked prepolymer may be formed using a polyol having an amine initiator or a polyol blend that includes at the polyol having an amine initiator, as previously described herein. The blocked prepolymer may comprise at least 3 wt %, 5 wt %, 10 wt %, 15 wt %, 20 wt %, 25 wt %, 30 wt %, 35 wt %, 40 wt %, and/or 45 wt % of the total weight of the acrylic plastisol composition. The blocked prepolymer comprising a polyol having an amine initiator may comprise up to 10 wt %, 15 wt %, 20 wt %, 25 wt %, 30 wt %, 35 wt %, 40 wt %, 45 wt %, and/or 50 wt % of the total weight of the acrylic plastisol composition. In exemplary embodiments, natural oil derived blocked prepolymer may comprise from 3 wt % to 50 wt %, 4 wt % to 30 wt %, 5 wt % to 20 wt %, 5 wt % to 15 wt %, and/or 6 wt % to 10 wt % of the total weight of the acrylic plastisol composition.

The acrylic plastisol composition may further comprise one or more powders such as acrylic powders (e.g., for providing physical strength). A known acrylic powder may be used. Exemplary powders include polymers from acrylic vinyl monomers, α,β-ethylenic unsaturated carboxylic esters, diene type monomers, vinyl ester monomers, vinyl cyanides, α,β-ethylenic unsaturated carboxylic acids, and epoxy type monomers.

According to exemplary embodiments, one or more acrylic powders may comprise at least 10 wt %, 15 wt %, 20 wt %, 25 wt %, 30 wt %, 35 wt %, 40 wt %, 45 wt %, and/or 50 wt % of the total weight of the acrylic plastisol composition. The one or more acrylic powders (b) may comprise up to 15 wt %, 20 wt %, 25 wt %, 30 wt %, 35 wt %, 40 wt %, 45 wt %, 50 wt %, and/or 55 wt % of the total weight of the acrylic plastisol composition. In exemplary embodiments, the one or more acrylic powders may comprise from 10 wt % to 60 wt %, 15 wt % to 50 wt %, 20 wt % to 40 wt %, and/or 22 wt % to 30 wt % of the total weight of the acrylic plastisol composition.

The acrylic plastisol composition may further comprise one or more plasticizers. A known plasticizer may be used in the acrylic plastisol composition. The plasticizer may be of phthalate ester types. The plasticizer may be Di-Isononylphthlate (DINP), Di-Isodecylphthlate (DIDP), and/or PALITINOL® available from BASF Corporation. The plasticisder may be of a type known to those skilled in the art of plastisol formulations.

The acrylic plastisol composition may further comprise one or more plasticizers. The one or more plasticizers may comprise at least 15 wt %, 20 wt %, 25 wt %, 30 wt %, 35 wt %, 40 wt %, and/or 45 wt % of the acrylic plastisol composition. The one or more plasticizers may comprise up to 20 wt %, 25 wt %, 30 wt %, 35 wt %, 40 wt %, 45 wt %, and/or 50 wt % of the acrylic plastisol composition. The plasticizer may be provided in an approximate amount from 10 wt % and 50 wt % (e.g., 15 wt % to 40 wt %, 20 wt % to 35 wt %, 25 wt % to 30 wt %, etc.) of the total weight of the acrylic plastisol composition.

The acrylic plastisol composition may further comprise one or more fillers (e.g., related to rheology, tensile strength, modulus strength, sheer strength, abrasion resistance, and/or cost). A known fillers may be used. Exemplary fillers include particulate inorganic and organic materials that are stable and may not melt at the temperatures encountered during the plastisol-forming reaction. The fillers may be selected from kaolin, montmorillonite, calcium carbonate, mica, wollastonite, talc, high-melting thermoplastics, glass, fly ash, carbon black, titanium dioxide, iron oxide, chromium oxide, azo/diazo dyes, phthalocyanines, dioxazines, and combinations or modifications thereof. Other exemplary cost lowering and rheology-controlling fillers can be used.

The one or more fillers may comprise at least 10 wt %, 20 wt %, 25 wt %, 30 wt %, 35 wt %, 40 wt %, 45 wt %, 50 wt %, and/or 55 wt % of the acrylic plastisol composition. The one or more fillers may comprise up to 25 wt %, 30 wt %, 35 wt. %, 40 wt. %, 45 wt. %, 50 wt. %, 55 wt.% or 60 wt. % of the acrylic plastisol composition. In exemplary embodiments, the one or more fillers may comprise from 15 wt % to 60 wt %, 20 wt % to 50 wt %, 25 wt % to 45 wt %, and/or 30 wt % to 40 wt % of the total weight of the acrylic plastisol composition.

The acrylic plastisol composition may further comprise one or more amine (e.g., amine cross-linkers) that promotes plastisol adhesion. A known amine may be used in the acrylic plastisol composition. Exemplary amine cross-linkers include modified polyamidoamine PVC plastisol adhesion promoters. Exemplary amines include NOURYBOND®270, NOURYBOND®272, and NOURYBOND®276. The one or more cross-linkers may comprise at least 0.05 wt %, 1 wt %, 2 wt %, 4 wt %, 5 wt %, 7 wt %, and/or 9 wt %. The one or more cross-linkers may comprise up to 1 wt %, 2 wt %, 4 wt %, 5 wt %, 7 wt %, 9 wt %, and/or 10 wt %. The amine cross-linker may be provided in an approximately amount from 0.1 wt % to 10 wt %, 0.5 wt % to 7 wt %, 1.0 wt % to 5 wt %, and/or 1.5 wt % to 3 wt % of the total weight of the acrylic plastisol composition.

The ratio of latent NCO (isocyanate group content) to amine functional units may from 0.1 to 5 in the plastisol composition.

The temperature range for thermal curing and/or deblocking may be from 100° C. to 200° C. (e.g., from 110° C. to 130° C., approximately 120° C., etc.). According to an exemplary embodiment, the plastisol composition may be cured for at 120° C. for a period of 30 minutes.

For adhesive and sealants applications, addition of prepolymers based on the self catalytically active polyol having an amine initiator described herein can reduce the use of amine catalyst and volatile organic compounds (VOCs) in the formulations. Normally, amine initiated polyols with higher functionality (e.g., >2) and lower molecular weight tend to be used for polyurethane rigid foam applications or as curatives for polyurethane elastomer applications because of their high reactivity and high functionality. The plastisol compositions comprising the viscous natural oil derived blocked prepolymer described herein may afford better tensile strength and elongation compared to currently available products.

As used here, the term “prepolymer” designates a reaction product of monomers, which has remaining reactive functional groups to react with additional monomers to form a polymer. An isocyanate-terminated prepolymer has isocyanate based functional groups remaining to react with, e.g., hydroxyl groups. The term “polyol” refers to an organic molecule having an average of greater than 1.0 hydroxyl groups per molecule. It may also include other functionalities, that is, other types of functional groups. The term “hydroxyl number” indicates the concentration of hydroxyl moieties in a composition of polymers, particularly polyols. A hydroxyl number represents mg KOH/g of polyol. A hydroxyl number is determined by acetylation with pyridine and acetic anhydride in which the result is obtained as the difference between two titrations with KOH solution. A hydroxyl number may thus be defined as the weight of KOH in milligrams that will neutralize the acetic anhydride capable of combining by acetylation with 1 gram of a polyol. A higher hydroxyl number indicates a higher concentration of hydroxyl moieties within a composition. The term “functionality” particularly “polyol functionality” is used herein to refer to the average number of active hydroxyl groups on a polyol molecule. As used herein, the functionality for polyols is the nominal functionality, i.e., the number of reactive groups present on the initiator.

The term “elongation” as applied to a polymer not in the form of a foam is used herein to refer to the percentage that the material specified can stretch (extension) without breaking. The result is expressed as a percentage of the original length of the polymer sample and is tested in accordance with the procedures of ISO 37:1994 unless stated otherwise. The term “tensile strength” as applied to a polymer not in the form of a foam is used herein to refer to a measure of how much stress that the material specified can endure before suffering permanent deformation. The result is typically expressed in Pascals (Pa) or pounds per square inch (psi) and is tested in accordance with the procedures of ISO 37:1994 unless stated otherwise.

All parts and percentages are by weight unless otherwise indicated. All descriptions of molecular weight are based on a number average molecular weight, unless otherwise indicated. Features described in connection with any aspect of the various embodiments discussed herein can be used in combination with any other aspect of the various embodiments.

### EXAMPLES

The particular materials and amounts thereof, as well as other conditions and details, recited in these examples should not be used to limit embodiments described herein. Unless stated otherwise all percentages, parts and ratios are by weight. Examples of the working examples are numbered while comparative samples are designated alphabetically.

A description of the raw materials used in the examples is as follows.
Isocyanate A An isocyanate based on 2,4-toluene diisocyanate (commercially available as Coronate T100 from Nippon Polyurethane Co., Ltd).
Polyol A An amine initiated (3,3′-diamino-N-methyl dipropylamine) tetrol having a hydroxyl number of approximately 57 mgKOH/g and a number average molecular weight of approximately 4,000 g/mol (available from The Dow Chemical Company under the trade designation VORANOL™VORACTIV™ 7000).
Polyol B A polyol that is a polyoxypropylene diol having a number average molecular weight of approximately 3,000 g/mol (available from The Dow Chemical Company under the trade designation VORANOL™ WD 2130).
Polyol C A polyol this is a polyoxypropylene triol having a number average molecular weight of approximately 3,000 g/mol (available from The Dow Chemical Company under the trade designation VORANOL™ 3022J).
Polyol D A polyol that is a polyoxypropylene triol having a number average molecular weight of approximately 4,000 g/mol (available from The Dow Chemical Company under the trade designation VORANOL™ 230-042).
CNSL A cashew nutshell liquid that includes 94 wt % of cardonal (available from Hua Da Sai Gao [i.e., HDSG of Beijing] Technology).
DINP A diisononyl phthalate ester (available from Sigma-Aldrich)
Nonylphenol An alkylephenol based on nonylphenol (available from Tokyo Chemical Industry).
Acrylic Resin An acrylic resin powder (available from the Mitsubishi Rayon Co. Ltd. under the trade designation DIANAL™ LP-3106).
CaCO₃ A calcium carbonate (available from the Shiraishi Chemical Co., Ltd., under the trade designation Whiton SSB calcium carbonate).
Modified CaCO₃ A fatty acid modified calcium carbonate (available from Shiraishi Chemical Co., Ltd., under the trade designation Lighton SB calcium carbonate).
Amine A polyamine having an amine value from approximately 230-250 mg KOH/g of polyamine (available from Sanho Chemical Co., LTD. under the trade designation Fujicure FXR-1090-FA as a latent curing agent).

For each of Working Examples 1 and 2, Comparative Examples A to E, and the TAKENATE® B7105 Comparative Example, the amounts and types of polyol and isocyanate according to the formulations in Table 1 are combined in a glass reactor having an approximate volume of 500 ml and stirred under a blanket of nitrogen. The polyol and isocyanate are reacted at a temperature of 80 degrees Celsius uncatalyzed for a period of approximately four hours to form an isocyanate terminated prepolymer. The resulting isocyanate terminated prepolymer is then characterized for free isocyanate content. The blocking agent is blended with the isocyanate terminated prepolymer to form the blocked prepolymer. The resulting blocked prepolymer is then characterized for free isocyanate content to confirm completion of the blocking reaction. Formulations used for producing the prepolymers are provided in Table 1, below.

TABLE 1
Blocked Prepolymer Formulation

| | | | | Comparative Examples | | | | | |
|---|---|---|---|---|---|---|---|---|---|
| | | Working | | (parts by weight) | | | | | |
| | | Examples | | | | | | | TAKEN |
| | | (parts by | | | | | | | ATE ® |
| Raw | | weight) | | | | | | | B7105 |
| material | Detail | 1 | 2 | A | B | C | D | E | (Mitsui) |
| Isocyanate A | TDI 100 | 8.8 | 8.9 | 4.5 | 9.6 | 11.7 | 8.8 | 11.0 | — |
| Polyol A | Amine | 2 | 5 | 1 | 2 | 2 | — | — | — |
| | initiated | | | | | | | | |
| | polyol | | | | | | | | |
| Polyol B | PO 3000 | — | — | — | — | — | — | 17.0 | — |
| | diol | | | | | | | | |
| Polyol C | PO 3000 | — | — | — | — | — | — | 68.0 | — |
| | triol | | | | | | | | |
| Polyol D | PO 4000 | 76.8 | 73.7 | 39.4 | 84.4 | 79.9 | 78.8 | — | — |
| | triol | | | | | | | | |
| CNSL | Natural oil | 12.4 | 12.4 | — | — | — | 12.4 | — | — |
| DINP | Diisononyl | — | — | 50.1 | — | — | — | — | — |
| | phthalate | | | | | | | | |
| Nonylphenol | Nonylphenol | — | — | 5.0 | — | — | — | — | |
| MEKO | Methyl | — | — | — | 4 | 6.4 | — | 4 | — |
| | ethyl | | | | | | | | |
| | ketone | | | | | | | | |
| | oxime | | | | | | | | |

| | | | | | | | | |
|---|---|---|---|---|---|---|---|---|
| Total (parts by weight) | 100 | 100 | 100 | 100 | 100 | 100 | 100 | — |
| Benzoyl chloride, ppm | 100 | 100 | 100 | 100 | 100 | 100 | 100 | — |
| Latent NCO % | 2% | 2% | 1% | 2% | 3% | 2% | 2% | 2% |
| Blocked prepolymer | 114,700 | 109,500 | 25,700 | 28,700 | 17,500 | 315,000 | 35,000 | 46,900 |
| viscosity, Pa.s | | | | | | | | |

The plastisol formulations incorporating the prepolymers from Table 1, above, are formed by mixing the prepolymers with the components depicted in Table 2, below, and curing at 120 degrees Celsius for 30 minutes.

TABLE 2
Plastisol Formulation

| | | | Comparative Examples | | | | | |
|---|---|---|---|---|---|---|---|---|
| | Working | | (parts by weight) | | | | | |
| | Examples | | | | | | | TAKEN |
| | (parts by | | | | | | | ATE ® |
| | weight) | | | | | | | B7105 |
| | 1 | 2 | A | B | C | D | E | (Mitsui) |
| Blocked | 8 | 8 | 16 | 8 | 8 | 8 | 8 | 8 |
| Prepolymer | | | | | | | | |
| according to | | | | | | | | |
| corresponding | | | | | | | | |
| Example | | | | | | | | |
| in Table 1 | | | | | | | | |
| Acrylic Resin | 24 | 24 | 24 | 24 | 24 | 24 | 24 | 24 |
| CaCO₃ | 19 | 19 | 19 | 19 | 19 | 19 | 19 | 19 |
| Modified | 19 | 19 | 19 | 19 | 19 | 19 | 19 | 19 |
| CaCO₃ | | | | | | | | |
| DINP | 28 | 28 | 20 | 28 | 28 | 28 | 28 | 28 |
| Amine | 2 | 2 | 2 | 2 | 2 | 2 | 2 | 2 |

Working Examples 1 and 2 have viscosities of 74.1 Pa*s and 55.5 Pa*s, respectively. Comparative Examples A-E have higher viscosities of 250.5 Pa*s, 84.4 Pa*s, 80.5 Pa*s, 130.0 Pa*s, and 82.5 Pa*s respectively. The TAKENATE® B7105 Comparative Examples has a viscosity of 78.5 Pa*s. Viscosity of the prepolymer samples is determined using a Brookfields viscometer according to ASTM D4889.

Physical properties of the plastisol formulations incorporating the prepolymers of Examples 1 and 2, Comparative Samples A to E, and the TAKENATE® B7105 Comparative Example are depicted in Table 3, below. Shore A hardness is determined using JIS K6251 Durometer Type A and methods corresponding to ISO 48:94 and ISO 7619:97. Tensile strength and elongation are determined using JIS K6251 Dampbel No. 3 and methods corresponding to ISO 37:94. Elongation refers to the percentage that the sample can stretch (extension) without breaking and the result is expressed as a percentage of the original length of the polymer sample. In particular, elongation measured as the value at break of an approximately 2 mm thickness sheet of the plastisol sample included the blocked prepolymer according to each of the examples. Tensile strength refers to a measure of how much stress the sample can endure before suffering permanent deformation and the result is expressed in Pascals (Pa).

Relative adhesion is determined by performing an adhesion test in which an approximately 500 micron thick coating using each of Working Examples 1 and 2, Comparative Samples A to E, and the TAKENATE® B7105 Comparative Example is formed on separate ED plates and cured at 130° C. for 30 minutes. After curing, the respective coatings on the separate ED plates are scratched with a nail to check relative adhesion so as to perform a relative adhesion scratch test. If relative large amounts of the coating is peeled from the ED plate during the scratch test, it is determined that the coating has bad or moderate relative adhesive properties. If relatively lower amounts to no amounts of the coating is peeled from the ED plate during the scratch test, it is determined that coating has excellent or good relative adhesive properties.

TABLE 3
Plastisol Physical Properties

| | | | Comparative Examples | | | | | |
|---|---|---|---|---|---|---|---|---|
| | | | | | | | | TAKEN |
| | Working | | | | | | | ATE ® |
| | Examples | | | | | | | B7105 |
| | 1 | 2 | A | B | C | D | E | (Mitsui) |
| Shore A | 60 | 59 | 60 | 59 | 57 | 57 | 57 | 57 |
| hardness | | | | | | | | |
| Tensile | 2.6 | 2.6 | 2.6 | 2.6 | 2.4 | 2.3 | 2.3 | 2.3 |
| strength, | | | | | | | | |
| Mpa | | | | | | | | |
| Elongation | 465 | 465 | 460 | 470 | 435 | 425 | 423 | 427 |
| at break | | | | | | | | |
| Relative | Ex- | Ex- | Ex- | Mod- | Good | Mod- | Bad | Bad |
| Adhesion | cel- | cel- | cel- | er- | | er- | | |
| | lent | lent | lent | ate | | ate | | |

Comparative Example A demonstrates similar plastisol physical properties, but the viscosity of the blocked prepolymer formulation is lower than desired for the intended use (see Table 1). Comparative Examples B and C demonstrate both good properties with respect to hardness, tensile strength, and elongation, but the relative adhesion is not as good when compared to Working Examples 1 and 2. Comparative Examples D, E, and TAKENATE® B7105 demonstrate good properties with respect to hardness, but diminished properties with respect to tensile strength, elongation, and relative adhesion compared to Working Examples 1 and 2.

1. A natural oil derived blocked prepolymer that is a reaction product of a composition, comprising:
an isocyanate terminated prepolymer that is the reaction product of a mixture that includes at least:
one or more polyols including at least one polyol having a secondary amine initiator or a tertiary amine initiator, and
a stoichiometric excess of one or more organic polyisocyanate components, the stoichiometric excess of isocyanate to alcohol moieties (NCO:OH) being from 1.1:1 to 4:1; and
a natural oil derived blocking agent,
the viscosity of the natural oil derived blocked prepolymer being from 50,000 Pa*s to 300,000 Pa*s.

2. The natural oil derived blocked prepolymer as claimed in claim 1, wherein the viscosity of the natural oil derived blocked prepolymer is from 75,000 Pa*s to 300,000 Pa*s.

3. The natural oil derived blocked prepolymer as claimed in claim 1, wherein the one or more polyols further includes at least one of one or more polyether polyols, one or more polyester polyols, and one or more polycarbonate polyols.

4. The natural oil derived blocked prepolymer as claimed in claim 1, wherein:
the one or more polyols includes the at least one polyol having a secondary amine initiator or a tertiary amine initiator in an amount from 1 wt % to 5 wt % and a polyoxypropylene containing polyol in an amount from 65 wt % to 85 wt %, based on the total weight of the blocked prepolymer composition,
the one or more organic polyisocyanate components is present in an amount from 5 wt % to 20 wt %, based on the total weight of the blocked prepolymer composition,
the natural oil derived blocking agent is present in an amount from 5 wt % to 20 wt %, based on the total weight of the blocked prepolymer composition, and
a blocking agent that is different from the natural oil derived blocking agent is present in an amount from 0 wt % to 5 wt % based on the total weight of the blocked prepolymer composition.

5. The natural oil derived blocked prepolymer as claimed in claim 4, wherein the polyoxypropylene containing polyol is an ethylene oxide capped polyoxypropylene triol.

6. The natural oil derived blocked prepolymer as claimed in claim 1, wherein the natural oil derived blocking agent is cashew nutshell liquid.

7. An acrylic plastisol composition, comprising:
a natural oil blocked prepolymer as claimed in claim 1;
one or more acrylic powders;
one or more plasticizers;
one or more amine cross-linkers; and
optionally, one or more fillers.

8. The acrylic plastisol composition as claimed in claim 7, comprising:
from 3 wt % to 50 wt % of the natural oil derived blocked prepolymer, based on the total weight of the acrylic plastisol composition;
from 10 wt % to 60 wt % of the one or more acrylic powders, based on the total weight of the acrylic plastisol composition; and
from 10 wt % to 50 wt % of the one or more plasticizers, based on the total weight of the acrylic plastisol composition.

9. The acrylic plastisol composition as claimed in claim 7, wherein the one or more acrylic powders is selected from a group of polymers comprising acrylic vinyl monomer, α,β-ethylenic unsaturated carboxylic ester, diene type monomer, vinyl ester monomer, vinyl cyanide, α,β-ethylenic unsaturated carboxylic acid, epoxy type monomer, and combinations thereof.

10. The acrylic plastisol composition as claimed in claim 7, wherein the one or more plasticizers is selected from a group of Di-Isononylphthlate (DINP), Di-Isodecylphthlate (DIDP), and combinations thereof.
